(19) United States
(12) Patent Application Publication
(10) Pub. No.: US 2004/0125516 A1
(43) Pub. Date: Jul. 1, 2004

(54) Assembly of ICs with blocking capacitors and printed circuit boards

(76) Inventors: Uwe Brand, Munchen (DE); Heinz Ibowski, Olching (DE)

Correspondence Address: MORRISON & FOERSTER LLP, 1650 TYSONS BOULEVARD, SUITE 300, MCLEAN, VA, 22102, US

(21) Appl. No.: 10/669,640

(22) Filed: Sep. 25, 2003

(30) Foreign Application Priority Data
Sep. 26, 2002 (DE) 102 44 976.7
Oct. 31, 2002 (DE) 102 50 919.0

(51) Int. Cl. H02H 7/16

(52) U.S. Cl. 361/15

(57) ABSTRACT

A method and arrangement for the advantageous assembly of blocking capacitors for an integrated circuit. An integrated circuit includes a BGA housing having a plurality of preferably ball-shaped connector pins. A printed circuit board is also provided, having conductor paths to which the housing of the integrated circuit is electrically and mechanically contacted by means of the connector pins. At least one blocking capacitor is spatially arranged between two connector pins of the housing and also between the printed circuit board and housing of the integrated circuit.

### CLAIM FOR PRIORITY

This application claims priority to German Application No. 10244976.7, filed Sep. 26, 2002, and German Application No. 10250919.0, filed Oct. 31, 2002, each filed in the German language, the contents of which are hereby incorporated by reference.

### TECHNICAL FIELD OF THE INVENTION

The present invention relates to an arrangement and method for the assembly of at least one blocking capacitor and printed circuit boards.

### BACKGROUND OF THE INVENTION

Due to the ever increasing integration of functionalities in existing integrated circuits (ICs), in particular ASICs and processors, there is a correspondingly growing number of inputs and outputs (pins). Because of the dynamic switching currents of these integrated circuits which increase with the operating frequency, an additional 30% to 50% of pins compared to the total number of pins are still required for the voltage supply.

The housings for these integrated circuits therefore have to have a correspondingly large number of pins, to enable connection to a printed circuit board and thus to other components as well.

If there is a very large number of pins for these integrated circuits, it is often customary to use housings in which the pins are arranged flat beneath the housing body, which is essentially rectangular. Ball grid array housings are preferably used having ball-shaped connector pins, which are arranged in a grid. The ball-shaped connector pins are frequently approx. 0.6 mm in diameter. The distance between the centers of the ball-shaped connector pins is preferably approx. 1/20 inch.

When assembling integrated circuits on printed circuit boards, it is generally problematic to arrange blocking capacitors favorably. These blocking capacitors are required in the power supply path of the integrated circuit, as, due to the relatively high line impedance of the supply lines (for example in the order of 100 Ohm), rapid current changes at high switching frequency cannot be offset via this channel. For the integrated circuit to function properly, it is therefore necessary to feed the current to the power supply terminals (power supply pins) via a low-ohm and broadband connection. For this purpose, these blocking capacitors are required in particular, which are connected to the supply voltage terminals with the lowest possible inductance. On the one hand, blocking capacitors must therefore be selected, which themselves have the lowest possible self-inductance.

Apart from self-inductance, the feed inductance between the blocking capacitors and IC pins is naturally crucial. It should therefore be ensured that the blocking capacitors are positioned as close as possible to the supply voltage pins.

FIG. 1 is a diagrammatic representation of a known assembly technique for an integrated circuit 1 in a housing body 8 on conducting paths 5 of a printed circuit board 4. As can be seen in FIG. 1, the integrated circuit 1 is directly contacted to the conducting paths 5, 7 of the printed circuit board 4 by means of, for example, ball-shaped connector pins 2, 3.

With the known technique according to FIG. 1, blocking capacitors 6 are arranged next to the housing 8 of integrated circuit 1 or on the side of the printed circuit board 4 facing away from the housing 8.

This known technique is disadvantageous in several ways. Because of the considerable connection lengths of the current paths between the blocking capacitors 6 and integrated circuit 1 due to the arrangement of blocking capacitors 6, high series feed inductances are produced, leading to a deterioration in the blocking characteristics.

Furthermore, the space requirements are greatly dependent on the number of blocking capacitors 6.

A further possibility not shown in the figures is to integrate the blocking capacitors in the housing of the integrated circuit itself. This variant; however, is disadvantageous in that it increases the housing costs, which means that this known technique can only be applied in special cases.

### SUMMARY OF THE INVENTION

The present invention relates to an arrangement comprising an integrated circuit in a housing with connector pins, a printed circuit board and at least one blocking capacitor. The invention also relates to a method for the assembly of at least one blocking capacitor. In addition, the invention relates to the assembly of suitable carriers.

The present invention also discloses a technique for assembling integrated circuits in housings, with it being possible to arrange the blocking capacitors at low cost, requiring little space and generating low feed inductances between the blocking capacitors and the integrated circuit.

According to one embodiment of the invention, an arrangement is proposed, comprising an integrated circuit in a housing, in turn comprising a plurality of connector pins. The arrangement also comprises a printed circuit board having conducting paths, to which the integrated circuit is electrically and mechanically contacted by means of the above-mentioned connector pins of the housing. In addition, at least one blocking capacitor is switched into a power supply path for the integrated circuit external to the housing.

According to the present invention, at least one blocking capacitor is spatially arranged between the connector pins of the housing and is electrically contacted thereto. In other words, the blocking capacitors in the grid are placed between the connector pins, or are positioned in slots or spaces not occupied by connector pins.

It is in particular possible to surround the integrated circuit by a BGA (ball grid array) housing, the connector pins of which are ball-shaped. This makes it possible to insert the connector pins through openings, preferably bore holes in a carrier, in particular a heat-resistant carrier foil. In this way it is possible for the blocking capacitor, of which there is at least one, and the printed circuit board to be positioned on the side of the carrier facing toward or away from the housing, depending on whether the carrier is arranged further toward the housing or further toward the printed circuit board.

The blocking capacitor, of which there is at least one, can be bonded to the carrier, preferably the carrier foil, between two openings. It can also be inserted into the carrier between two openings, such that both sides of the blocking capacitor project from the carrier and the carrier occupies a central position.

According to another embodiment of the present invention, a carrier is provided which comprises openings, through which connector pins of a housing surrounding an integrated circuit can be inserted and at least one blocking capacitor, which is mounted on the carrier between two openings or which is centrally positioned compared to either side of the carrier. The carrier can be made of a heat-resistant foil.

According to still another embodiment of the present invention, there is a method is provided to assemble at least one blocking capacitor. This blocking capacitor is arranged in a power supply path for an integrated circuit, which has a housing with a plurality of connector pins. The connector pins are electrically and mechanically contacted to conducting paths of a printed circuit board arranged in proximity to the housing. In addition, the blocking capacitor, of which there is at least one, is spatially arranged between the printed circuit board and integrated circuit and is contacted to the connector pins of the housing of the integrated circuit.

In this way, the blocking capacitor, of which there is at least one, can be assembled before assembly onto or into the carrier between two openings thereof. The connector pins are thus inserted through the openings of the carrier positioned between the housing and the printed circuit board.

### BRIEF DESCRIPTION OF THE DRAWINGS

Further features, advantages and characteristics of the present invention are described in more detail for the person skilled in the art by means of the following detailed description of an exemplary embodiment referring to the figures of the accompanying drawings.

FIG. 1 shows a known technique for assembling integrated circuits in housings with blocking capacitors and a printed circuit board.

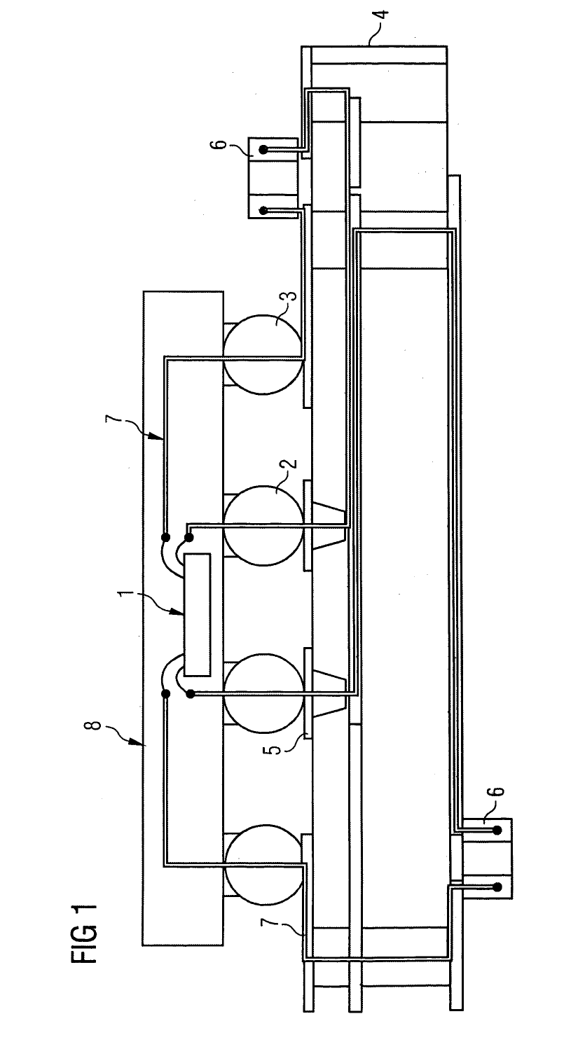

FIG. 2 shows a first phase of the technique according to the invention to assemble blocking capacitors between connector pins of a housing of an integrated circuit.

FIG. 3 shows the final phase of this assembly technique according to the invention.

### DETAILED DESCRIPTION OF THE INVENTION

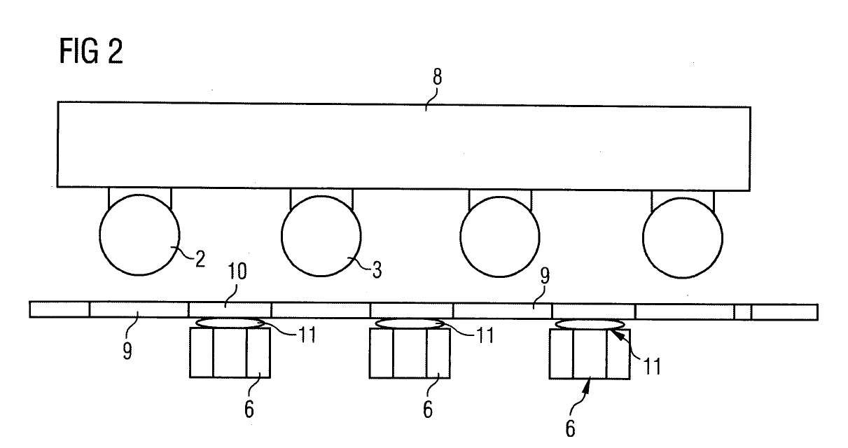

The housing 8 of an integrated circuit can be seen in FIG. 2, with the housing 8 preferably being a BGA (ball grid array) housing 8 having ball-shaped connector pins 2, 3. From the exemplary embodiment shown, which does not show the printed circuit board, it can be seen that, as a further component, a carrier foil 10 is provided, having openings, e.g. bore holes 9, for the ball-shaped connector pins 2, 3 of the BGA housing. The openings, e.g. bore holes 9, are arranged and dimensioned such that the ball-shaped connector pins 2, 3 of the BGA housing 8 can insert into them, if the carrier foil 10 is correctly aligned therewith during the assembly.

It can also be seen from FIG. 2 that the blocking capacitors 6 are mounted on the side of the foil 10 facing away from the BGA housing 8 between openings 9 of the foil 10 and are in particular connected to the foil 10 by means of a bonding 11. Although this is not shown in FIG. 2, it is conceivable for the blocking capacitors to be mounted on the side of the foil 10 facing toward the BGA housing 8 between the openings 9 of the foil 10 or to be inserted into the foil 10, such that both sides of the blocking capacitors project from the foil.

In the assembly according to the invention, the preassembled carrier foil with blocking capacitors is thus connected first to the BGA housing 8, by inserting the ball-shaped connector pins 2, 3 into the openings 9 of the carrier foil 10.

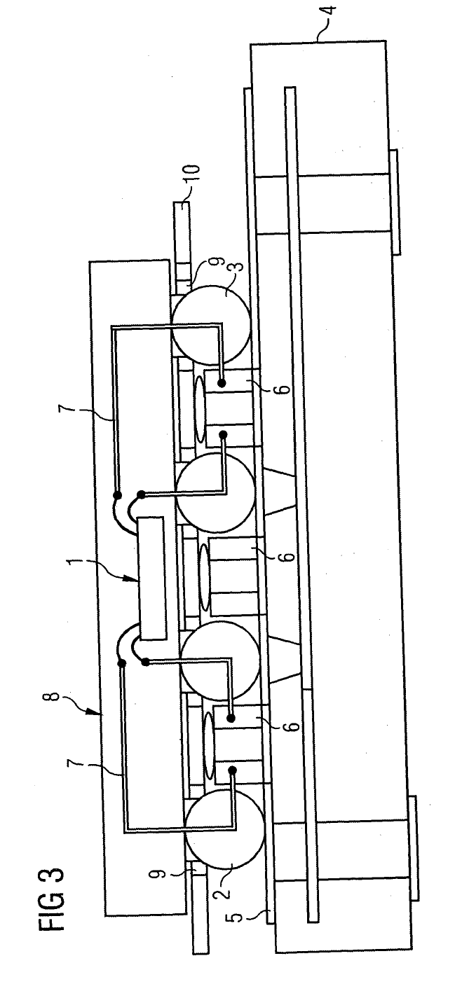

Then, as shown in FIG. 3, the ball-shaped connector pins 2, 3 of the BGA housing 8 are soldered to the conducting paths 5 of the printed circuit board 4 by means of contacting. This creates an electrical and mechanical connection between the printed circuit board 4 and the integrated circuit 1 within the BGA housing 8. The blocking capacitors 6 which are mounted on and, in particular, bonded to the carrier foil 10, are now positioned spatially on the one hand between the printed circuit board 4 and the BGA housing 8 and on the other hand, again spatially, between the ball-shaped connector pins 2, 3 of the BGA housing 8. At the same time in this phase, the blocking capacitors 6 are also soldered to the conducting paths 5.

As can be seen in FIG. 3, the electrical contacting between the blocking capacitors and the respective connector pin 2, 3 of the power supply for the integrated circuit 1 takes place via electrical conducting paths 5. As an alternative or in addition, it is also naturally possible for the blocking capacitors 6 to be mechanically and/or electrically contacted to the ball-shaped connector pins 2 and/or 3.

As shown in FIG. 3, it is thus advantageous for the current path 7 now created between the blocking capacitors 6 and the integrated circuit 1 to be considerably reduced, which in turn will improve the blocking characteristics.

The invention therefore provides for the direct attachment of the blocking capacitors to the connector pins (“balls”).

This produces the following advantages:

minimum series inductances for blocking capacitors external to the housing and thus effective blocking of discrete sets)

no additional space requirements on the printed circuit board, and

the technology according to the invention is compatible with the available fabrication techniques for SMD (surface mounted device) components.

The direct application of blocking capacitors to the supply voltage pins on the same side of the printed circuit board thus reduces the parasitic inductances connected to the feed lines.

It is pointed out that FIGS. 2 and 3 only show an exemplary embodiment enabling the use of a carrier foil fabricated specifically for ASICs and having blocking capacitors bonded thereto (e.g. heat-resistant foil with a hole grid in line with the BGA balls). When assembling the printed circuit board, this carrier foil is treated as a separate component, which is precisely positioned beneath the BGA housing.

Alternatively, it is possible to bond individual blocking capacitors, also specific to ASICs, to the printed circuit board between the terminal paths of the BGA balls using what are referred to as pick-and-place machines.

What is claimed is:

1. An arrangement, comprising:
an integrated circuit, having a housing with a plurality of connector pins;
a printed circuit board having conducting paths, to which the integrated circuit is electrically and mechanically contacted by connector pins; and
at least one blocking capacitor, which is switched into a power supply path for the integrated circuit, wherein
the blocking capacitor, of which there is at least one, is spatially arranged between the connector pins of the housing and is electrically contacted to the connector pins.

2. The arrangement according to claim 1, wherein the integrated circuit has a ball grid array housing with ball-shaped connector pins.

3. The arrangement according to claim 1, wherein the integrated circuit with the housing, the connector pins of which are inserted through openings of a carrier arranged between the housing and the printed circuit board.

4. The arrangement according to claim 3, wherein the openings are in the form of bore holes.

5. The arrangement according to claim 3, wherein the blocking capacitor, of which there is at least one, is positioned on a side of the carrier facing away from the housing.

6. The arrangement according to claim 3, wherein the blocking capacitor, of which there is at least one, is positioned on a side of the carrier facing toward the housing.

7. A carrier, comprising:
openings, through which connector pins of a housing surrounding an integrated circuit can be inserted; and
at least one blocking capacitor, which is mounted on the carrier between the openings.

8. A carrier, comprising:
openings, through which connector pins of a housing surrounding an integrated circuit can be inserted; and
at least one blocking capacitor, which is inserted into the carrier between the openings, such that the blocking capacitor is centrally positioned compared to the carrier sides.

9. The carrier according to claim 7, wherein the openings are in the form of bore holes.

10. The carrier according to claim 7, wherein the blocking capacitors are bonded onto the carrier.

11. The carrier according to claim 7, wherein the carrier is made out of a heat-resistant foil.

12. The arrangement according to claim 1, wherein a carrier comprising openings, through which connector pins of a housing surrounding an integrated circuit can be inserted, and at least one blocking capacitor, which is mounted on the carrier between the openings, is introduced between the housing and printed circuit board.

13. A method for assembling at least one blocking capacitor, comprising:
arranging the at least one blocking capacitor in a current supply path for an integrated circuit, having a housing with a plurality of connector pins, which are electrically and mechanically contacted to conducting paths of a printed circuit board arranged in proximity to the housing; and
spatially arranging the at least one blocking capacitor between the printed circuit board and the integrated circuit and is contacted to the connector pins of the housing of the integrated circuit.

14. The method according to claim 13, wherein the blocking capacitor, of which there is at least one, is assembled before assembly onto or into a carrier between openings thereof.

15. The method according to claim 14, wherein the connector pins are inserted through the openings of the carrier positioned between the housing and the printed circuit board.

16. The carrier according to claim 8, wherein the openings are in the form of bore holes.

17. The carrier according to claim 8, wherein the blocking capacitors are bonded onto the carrier.

18. The carrier according to claim 8, wherein the carrier is made out of a heat-resistant foil.

19. The arrangement according to claim 1, wherein a carrier comprising openings, through which connector pins of a housing surrounding an integrated circuit can be inserted, and at least one blocking capacitor, which is inserted into the carrier between the openings, such that the blocking capacitor is centrally positioned compared to the carrier sides, is introduced between the housing and printed circuit board.
